(19) United States
(12) Patent Application Publication
(10) Pub. No.: US 2015/0002931 A1
(43) Pub. Date: Jan. 1, 2015

(54) Directional polarization preserving screen

(71) Applicant: RealD Inc., Beverly Hills, CA (US)

(72) Inventor: David A. Coleman, Louisville, CO (US)

(21) Appl. No.: 14/319,300

(22) Filed: Jun. 30, 2014

Related U.S. Application Data
(60) Provisional application No. 61/841,086, filed on Jun. 28, 2013.

(51) Int. Cl. G03B 21/60

(52) U.S. Cl. CPC G03B 21/60
USPC 359/459

(57) ABSTRACT

A directional polarization preserving front projection screen may be preferably produced using an engineered surface. Unlike statistical surfaces, engineered surfaces may provide locally specular reflections, with little to no bulk scatter, while substantially eliminating features smaller than a wavelength of illumination and thus true depolarization. Most, if not all, contours contributing to the slope probability density can be engineered to achieve a desired macroscopic gain profile. The screen may diffuse light by using locally specular reflections, in which a bias angle introduced to the gain profile of the screen may be determined by the slope of the ramps, and with resets that may be substantially hidden from projector illumination.

### CROSS-REFERENCE TO RELATED APPLICATION

This application relates and claims priority to commonly-assigned U.S. Provisional Patent Application No. 61/841,086, filed Jun. 28, 2013, entitled “Directional polarization preserving screen,” (Attorney Ref. No.: 95194936.365000), which is herein incorporated by reference in its entirety.

### TECHNICAL FIELD

This disclosure generally relates to projection screens and more specifically relates to polarization preserving projection screens.

### BACKGROUND

A recent trend in front projection systems is toward ultra-short-throw (UST) projection systems, which places the projector extremely close to the screen. In settings such as classrooms, these arrangements allow presenters to view the audience without looking into the projection lens. The system is also more practical in that projector and screen are essentially co-located. The screen frame can provide a mounting structure for the projector, or it can be placed on a pedestal at the foot of the screen, and power is typically more conveniently accessed.

### SUMMARY

According to one aspect of the present disclosure, a directional polarization preserving screen may include a substrate and a periodic diffuser structure disposed on the substrate. The period structure may include a plurality of illuminated facets and a plurality of occluded facets, in which the illuminated and the occluded facets are connected to and alternate with one another respectively, and the illuminated facets substantially direct light to a predetermined area. The periodic diffuser structure may allow incident light to undergo locally specular reflections and the plurality of occluded facets may be substantially hidden from projector illumination. Additionally, the plurality of illuminated facets may include features smaller than a wavelength of illumination and may be smaller than the resolvable area on the substrate. In one example, the illuminated facets may be smaller than approximately 600 microns. In another example, the illuminated facets may be smaller than the pixel size of a projector.

Continuing the discussion, the plurality of illuminated facets and the plurality of occluded facets may all be continuous horizontal facets. Stated differently, the slope of the illuminated and occluded facets may be the same along the horizontal of the screen. In another example, the plurality of illuminated facets may have a variable slope and the variable slope may change vertically, or along the vertical. The slope of the plurality of illuminated facets may approximate an elliptical surface. The plurality of illuminated and occluded facets may be coated with an engineered polarization preserving pigment.

In another aspect of the disclosure, a method for directing projection light may include allowing projection light to reflect off of a plurality of illuminated facets disposed on a projection screen and also may include substantially preventing projection light from reflecting off of a plurality of occluded facets disposed on the projection screen, in which the illuminated and occluded facets connect to and alternate with one another, respectively. The bias angle may be primarily determined from the slope of the illuminated facets. The method may also include allowing ambient light to be steered away from the predetermined area. Additionally, the method may also include allowing the projection light that reflects off of a plurality of illuminated facets disposed on a projection screen, to be directed to a predetermined area. Also, the method may allow incident light to undergo locally specular reflections. Continuing the discussion, the method may include approximating an elliptical surface with the slope of the plurality of illuminated facets. The method may further include coating the plurality of illuminated and occluded facets with an engineered polarization preserving pigment.

### BRIEF DESCRIPTION OF THE DRAWINGS

FIG. 1 illustrates a schematic diagram of a projection system geometry and coordinate system;

FIG. 2 illustrates a schematic diagram of another projection system geometry and the center of distribution of light, in accordance with the present disclosure;

FIG. 3 illustrates a schematic diagram of a blazed structure of a projection screen surface, in accordance with the present disclosure;

FIG. 4 illustrates a schematic diagram of the draft slope of a projection screen surface, in accordance with the present disclosure;

FIG. 5 illustrates a schematic diagram of the global minimum and maximum slope of a projection system, in accordance with the present disclosure;

FIG. 6 illustrates a schematic diagram of the finite radius limitation of a projection screen surface, in accordance with the present disclosure; and

FIG. 7 illustrates a schematic diagram of the seaming of a projection screen, in accordance with the present disclosure.

### DETAILED DESCRIPTION

According to one aspect of the present disclosure, a directional polarization preserving screen may include a substrate and a periodic diffuser structure disposed on the substrate. The period structure may include a plurality of illuminated facets and a plurality of occluded facets, in which the illuminated and the occluded facets are connected to and alternate with one another respectively, and the illuminated facets substantially direct light to a predetermined area. The periodic diffuser structure may allow incident light to undergo locally specular reflections and the plurality of occluded facets may be substantially hidden from projector illumination. Additionally, the plurality of illuminated facets may include features smaller than a wavelength of illumination and may be smaller than the resolvable area on the substrate. In one example, the illuminated facets may be smaller than approximately 600 microns. In another example, the illuminated facets may be smaller than the pixel size of a projector.

Continuing the discussion, the plurality of illuminated facets and the plurality of occluded facets may all be continuous horizontal facets. Stated differently, the slope of the illuminated and occluded facets may be the same along the horizontal of the screen. In another example, the plurality of illuminated facets may have a variable slope and the variable slope may change vertically, or along the vertical. The slope of the plurality of illuminated facets may approximate an elliptical surface. The plurality of illuminated and occluded facets may be coated with an engineered polarization preserving pigment.

In another aspect of the disclosure, a method for directing projection light may include allowing projection light to reflect off of a plurality of illuminated facets disposed on a projection screen and also may include substantially preventing projection light from reflecting off of a plurality of occluded facets disposed on the projection screen, in which the illuminated and occluded facets connect to and alternate with one another, respectively. The bias angle may be primarily determined from the slope of the illuminated facets. The method may also include allowing ambient light to be steered away from the predetermined area. Additionally, the method may also include allowing the projection light that reflects off of a plurality of illuminated facets disposed on a projection screen, to be directed to a predetermined area. Also, the method may allow incident light to undergo locally specular reflections. Continuing the discussion, the method may include approximating an elliptical surface with the slope of the plurality of illuminated facets. The method may further include coating the plurality of illuminated and occluded facets with an engineered polarization preserving pigment

A recent trend in front projection systems is ultra-short-throw (UST), which places the projector extremely close to the screen. In settings such as classrooms, these arrangements allow presenters to view the audience without looking into the projection lens. The system is also more practical in that projector and screen are essentially co-located. The screen frame can provide a mounting structure for the projector (or it can be placed on a pedestal at the foot of the screen), and power is typically more conveniently accessed.

Throw ratios can be <0.3 for some systems, resulting in very aggressive incidence angles on the screen surface. A throw ratio is the ratio of the distance between the projector and the screen to the screen width. For example, in some movie theaters, the average throw-ratio may be approximately 2.0.

A true Lambertian scattering surface produces a uniformly bright image, independent of the angle of arrival. Such surfaces do not exactly exist in practice, but reasonable approximations can be fabricated. Moreover, adjustments in projected intensity (lumens/sr) can be made to compensate for geometry and sensitivity to projection angle. Assuming a uniform illuminance (lumens/m²) and a BRDF independent of incidence angle, the screen displays uniform luminance. For a matte-white (Lambertian-like) screen, the intensity is proportional to the cosine of the viewing angle with respect to the surface normal. Accounting for projected area, this gives a uniform brightness.

In the event that the projector outputs sufficient lumens that brightness objectives can be met with a Lambertian screen, such a screen can be considered optimum in the sense that the brightness is uniform at this level over the full locus of viewing angles. Another important factor: a system with UST can provide this result independent of projection angles. However, in the event that there are insufficient lumens to achieve brightness goals with a Lambertian screen, increased gain is usually desired. When a gain screen is employed, performance immediately becomes a strong function of system geometry.

Gain screens can be realized using a number of technologies, though most are based on statistical surfaces (which may involve both surface and bulk scatter). Statistical surfaces, such as metallic coatings used for silver-screens, tend to produce azimuthally symmetric Gaussian-like gain profiles, with peak reflectivity in the specular direction of the substrate. In some instances, a coating is used which increases the gain over a small range of angles near the peak, while the profile has a Lambertian-like character at larger angles. But regardless of the details of the gain profile, a gain screen cannot be considered independent of the geometry associated with projection and viewing.

More traditional cinematic projection environments were designed with modest throw ratios, typically about 2.0, with the projector located above screen center and the audience below screen center. Most statistical surfaces tend to produce non-directional diffusion, so the gain profile has azimuthal symmetry, with peak gain along the substrate normal. The peak observed brightness is along the specular direction, coinciding with the point on the screen at which the substrate normal bisects the projection and viewing angles. Again, in a traditional projection environment, a symmetric gain profile is often near optimum.

In an UST projection arrangement, a large bias angle is introduced to place the projector in close proximity to the screen, such that it does not occlude the viewing area. A bias angle may be the angle from which the screen is best viewed. The bias angle may be measured with respect to a perpendicular ray extended from the screen surface. The combination of closeness and bias angle results in extremely aggressive projection angles, particularly at the extreme opposite side of the screen from the projector. But a typical gain screen only provides a brightness benefit if the viewing zone contains (and is ideally centered on) the specular direction. A typical gain screen in this context would tend to steer an even greater proportion of the light toward the ceiling or floor, thus exacerbating brightness issues. In order to achieve the benefits of a gain-screen, the surface topography may desirably provide both directionality and diffusion. As it is not practical to tip the screen at sufficiently steep angles, this may be performed using a structure anecdotal to a Fresnel lens, in which the structure may contain a periodic structure of ramps and resets. The topography on the ramps and resets may be created with an acrylic coating on the screen substrate, other cast polymeric coating, or by directly embossing the substrate texture, or any other appropriate process. However, it is also possible that the engineered structure on the ramps and resets may be comprised of the same material as the ramps and resets and both features (engineered structure and the ramps and resets) may be a single engineered layer. The screen substrate may be any type of high elastic modulus material including, but not limited to, polycarbonate (PC), PET, and so forth. The ramps may be illuminated facets that substantially direct light to a predetermined location such as a viewing area. The resets may be occluded facets that are optically hidden, so that the projection light may not reflect off of the occluded facets or resets. The terms ramps and illuminated facets may be used interchangeably herein for discussion purposes only and the terms resets and occluded facets may also be used interchangeably herein for discussion purposes only. The ramps and resets may be connected to and alternate with one another respectively.

Another typical requirement of a projection screen is to provide a stereoscopic image when viewed through passive glasses, such as the glasses used in RealD cinema systems that use left- and right-eye filters having a polarizer layer and a retarder layer. The filters are designed to selectively allow or block opposite handed circularly polarized light. This system may employ a screen surface that preserves the polarization states of incident light reflected back to the viewer, as generally described, for example, in commonly-owned U.S. Pat. Nos. 7,898,734, 8,169,699, and 8,194,315, all of which are herein incorporated by reference in their entireties, for all purposes. According to the present disclosure, the screen diffuses light by using locally specular reflections, in which a bias angle introduced to the gain profile of the screen may be determined by the slope of the ramps, and with resets that may be substantially hidden from projector illumination.

Another desired characteristic for a front-projection screen is ambient light rejection. According to the present disclosure, the periodic diffuser structure can be used to steer ambient light away from the viewing locus. For instance, if the projector is located at the foot of the screen, with viewing substantially normal to the screen substrate, light impinging on the screen surface from overhead lights may be directed away from the viewing zone.

According to the present disclosure, a directional polarization preserving front projection screen may be preferably produced using an engineered surface. Unlike statistical surfaces, engineered surfaces may provide locally specular reflections, with little to no bulk scatter, while substantially eliminating features smaller than a wavelength of illumination and thus true depolarization. Most, if not all, contours contributing to the slope probability density can be engineered to achieve a desired macroscopic gain profile. These screens are manufactured typically using a UV embossing process with a seamless cylindrical embossing tool, followed by vacuum metallization. Such processes provide a much greater level of design control as needed to realize the screen of the present disclosure.

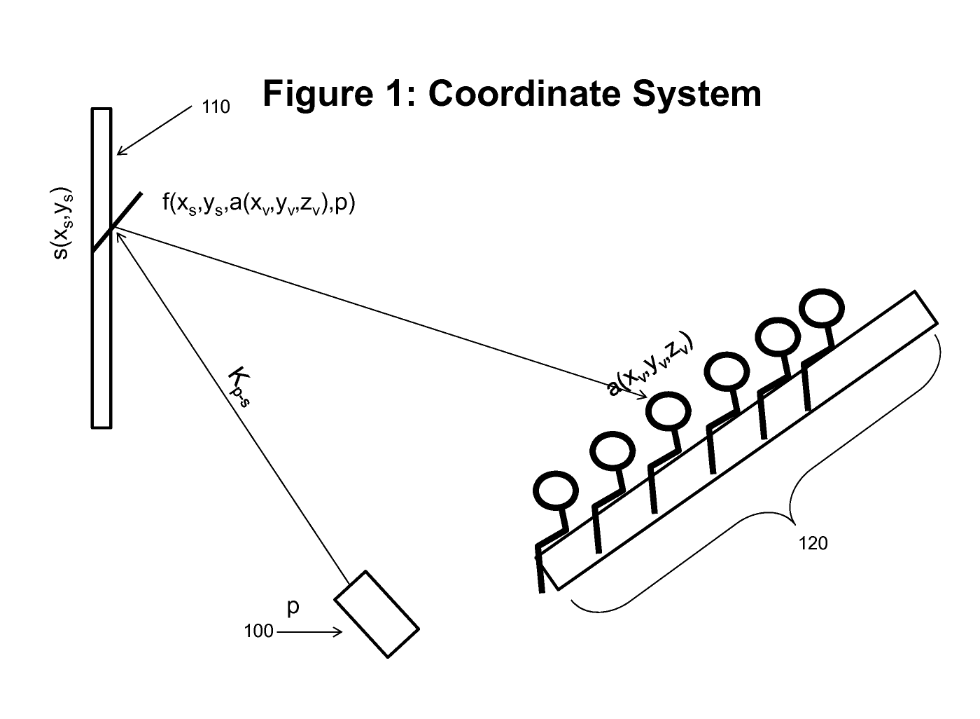

Consider a projection viewing environment shown in FIG. 1. FIG. 1 illustrates a schematic diagram of a projection system geometry and coordinate system. The projector position is at location 100, the screen is located at surface 110 and the audience occupies area 120. The projector may have a position p, the screen may have a location (s) with coordinate xₛ, yₛ or s(xₛ, yₛ), and there may be a location (a) in the audience with coordinates xᵥ, yᵥ, zᵥ or a(xᵥ, yᵥ, zᵥ). Additionally, in FIG. 1, there may be a vector Kₚ₋ₛ for light traveling from the projector to the location on the screen s(xₛ, yₛ) and a facet located on the screen with facet 130 with facet normal f(xₛ,yₛ,a(xᵥ,yᵥ,zᵥ),p). For simplicity and discussion purposes only, we will consider only a 2D cross section of the environment. For convenience and clarity we will locate the projector between the audience and the screen and below the bottom edge of the screen. However, it should be noted that these techniques can be generalized to arbitrary geometries (viewer, projector, and screen locations) in which the projector may be located in almost any position in relation to the screen.

At any location s(xₛ,yₛ) on the screen surface, light from the projector arrives along vector k=p-s and may desirably illuminate most to all points within the viewing area. For conventional screens, this means that the screen surface may desirably scatter light into the region a 120. However, for polarization preserving screens as described in commonly-owned U.S. Pat. Nos. 7,898,734, 8,169,699, and 8,194,315, all of which are herein are incorporated by reference in their entirety; this may be accomplished by an ensemble of facets as described herein. Stated differently, for any specific viewing location a(xᵥ,yᵥ,zᵥ), there may exist at least one facet f(xₛ,yₛ,a(xᵥ,yᵥ,zᵥ),p) or a plurality of such facets to specularly reflect light from the projector to that viewer. Within any resolvable area on the screen there may be a population F(xₛ,yₛ,a,p) of facets to direct light to all locations within the viewing area.

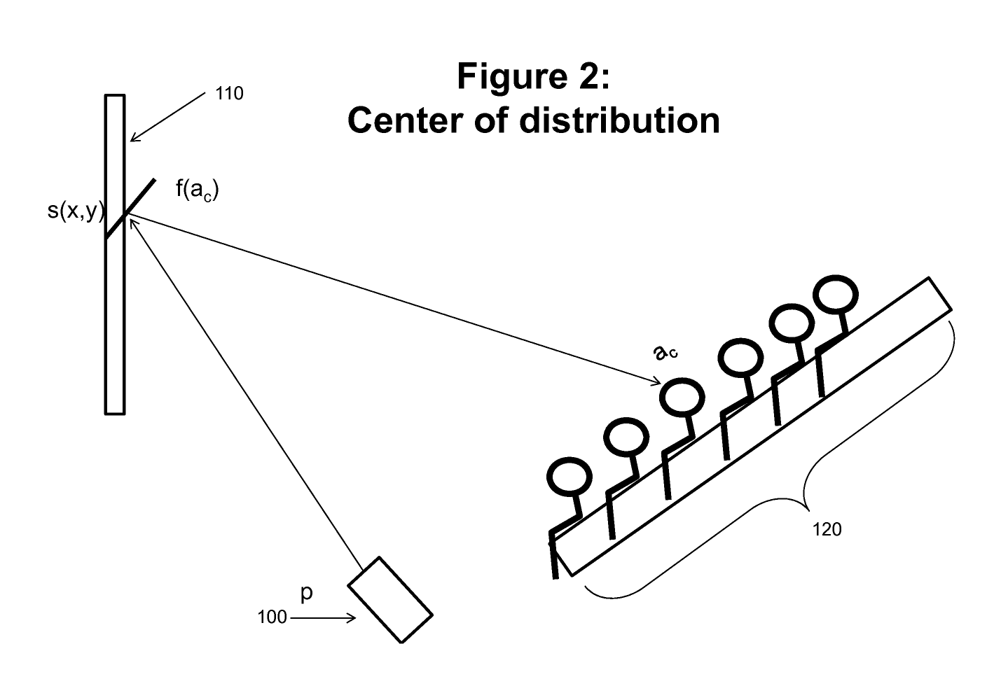

In many cases, it may be desirable to distribute the light symmetrically about the centroid a_{c}, of the viewing region as shown in FIG. 2. FIG. 2 illustrates a schematic diagram of another projection system geometry and the center of distribution of light. In this case, the ideal local mean facet normal can be written (neglecting normalization):

$$\vert F ( {x}_{s} , {y}_{s} , {a}_{c} , p ) \vert = ( \frac{{a}_{c} - s ( {x}_{s} , {y}_{s} )}{\vert {a}_{c} - s ( {x}_{s} , {y}_{s} ) \vert} + \frac{p - s ( {x}_{s} , {y}_{s} )}{\vert p - s ( {x}_{s} , {y}_{s} ) \vert} ) \qquad ( equation\_ 1 )$$

Integrating equation_{—}1 over the surface of the screen may generally result in a three dimensional elliptical mirror. Locally, the surface may then require additional topography as described in U.S. Pat. No. 7,898,734, which is herein incorporated by reference in its entirety, to distribute light throughout the viewing area. In principle, this surface may be manufactured directly on a relatively small scale but a more practical solution may be to manufacture the smooth elliptical surface and then spray a micro-structured pigment over the surface as described in U.S. Pat. No. 8,169,699, which is herein incorporated by reference in its entirety.

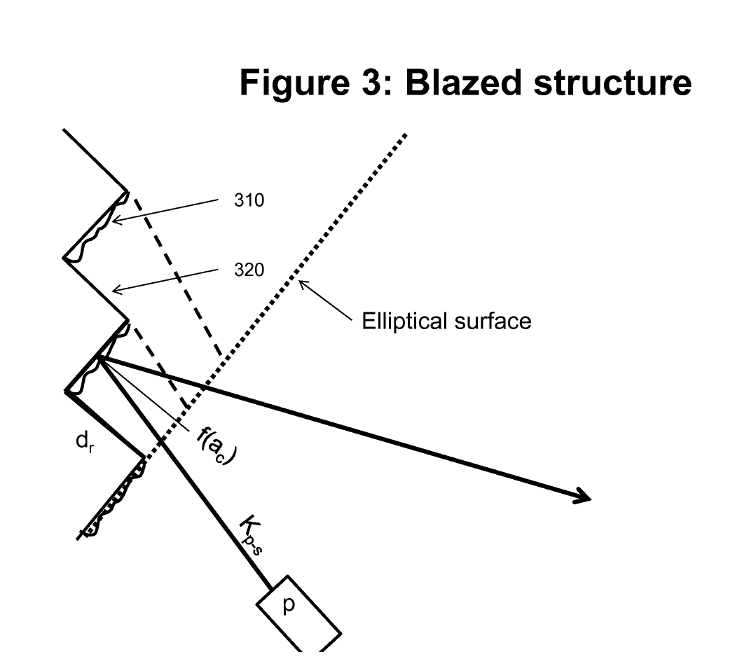

In most applications, it may be more practical to use a planar surface as the projection screen. To accomplish this, the elliptical surface can be replaced by a Fresnel reflector as shown in FIG. 3. FIG. 3 illustrates a schematic diagram of a blazed structure of a projection screen surface. As illustrated in FIG. 3, at any point on the screen, the illuminated facets or the reset facets, fᵣ, may have a slope greater than the light ray Kₚ₋ₛ . In FIG. 3, an illuminated facet may have the same or substantially similar slope as the elliptical surface previously discussed. The slope of the illuminated facets may vary vertically along the surface of the screen to approximate the slope of the elliptical surface with Fresnel reflectors. Fresnel reflectors may reflect and focus light to a common focal point amongst the reflectors. The projection screen surface may be comprised of an array of facets each of which locally satisfies equation_{—}1. The array of facets may include illuminated facets 310 and occluded facets 320. The illuminated facets may substantially direct light to a predetermined location such as a viewing area. The occluded facets may be optically hidden, so that the projection light may not reflect off of the occluded facets. The terms ramps and illuminated facets may be used interchangeably herein for discussion purposes only and the terms resets and occluded facets may also be used interchangeably herein for discussion purposes only.

As illustrated in FIG. 3, the illuminated facets may be coated with a polarization preserving engineered pigment or engineered coating as generally discussed in U.S. Pat. No. 8,169,699. The engineered coating may be sprayed on such that it covers only the illuminated facets as shown in FIG. 3. Additionally, the engineered coating may cover both the illuminated and the occluded facets (not shown).

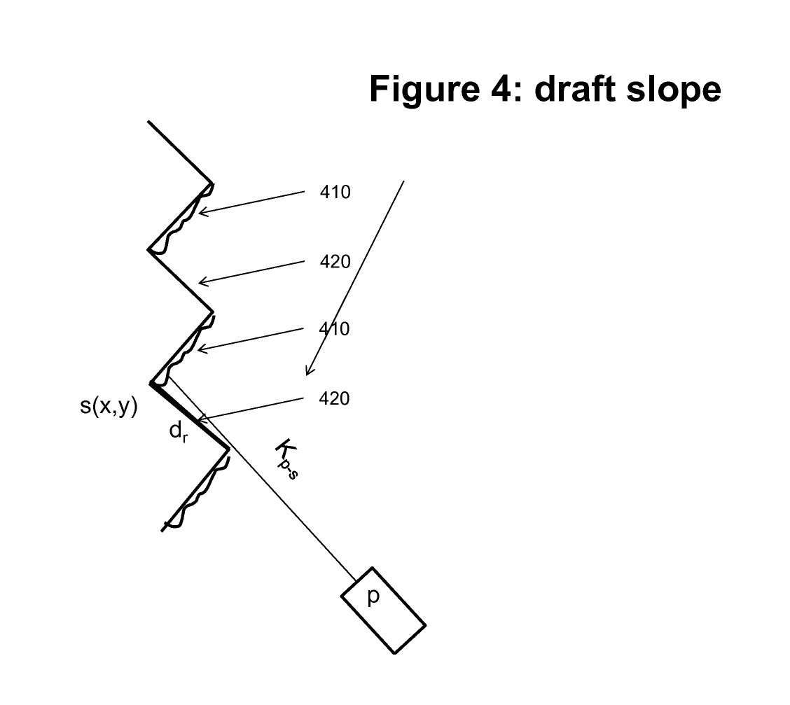

FIG. 4 illustrates a schematic diagram of the draft slope of a projection screen surface. Similar to FIG. 3, FIG. 4 illustrates that a reset draft or occluded facet, dr, 420, may have a slope greater than the incident angle of the incoming light rays from the projector. Additionally, at any point on the screen, the reset drafts or occluded facets may have a slope greater than the incident angle of the incoming light Kₚ₋ₛ from the projector.

The illuminated and occluded facets may be connected to and alternate with one another, respectively. Stated differently, connecting the illuminated facets are “reset” drafts dᵣ, or occluded facets, that may be sloped sufficiently to be shaded from the projection rays such that the reset drafts may be optically hidden from the projection light rays. In order to minimize visible artifacts due to the facets, the facets, both illuminated and occluded, may be smaller than the resolvable area on the screen. Therefore, the maximum size may primarily depend upon the expected minimum viewing distance. For viewing distances of approximately two meters and for typical 20/20 visual acuity, facets may be less than about 580 microns. It may also be desirable for the facet size to be significantly smaller than the digital projector pixel size in order to ensure uniform sampling of the facets for each pixel. Other types of projectors may be used as well including, but not limited to, flying spot projection, laser illuminated phosphor projection, and so forth. For an HD (1920×1080 resolution) projector illuminating an approximately two meter wide screen, the pixel size may be typically around one mm.

For 2D projection screens, it is not critically important to completely shadow the reset drafts or occluded facets. However, for polarization preserving screens, the drafts may be substantially shadowed in order to prevent multiple reflections from the surface. By preventing multiple reflections from the screen surface, polarization may be better preserved. The desired draft slope may depend upon the projector position as well as the specific location on the screen. For example, if the projector is at the same height as the bottom of the screen, then the drafts at the bottom of the screen may be undercut, with a slope greater than 90 degrees, in order to be shadowed. Therefore, it may be advantageous to position the screen either completely below or completely above the screen in order avoid including undercut facets on the screen surface. The minimum draft angle can then be written:

θₘᵢₙ=tan⁻¹t/h (equation_{—}2)

in which θₘᵢₙ is the minimum draft slope, t is the distance from the projector to the screen and h is the distance of the projector below the bottom, or above the top, of the screen.

In some applications, it may be possible to populate a sufficiently small sheet with an array of square, hexagonal, triangular, and so forth, facets that individually optimize the reflection at each point on the screen. However, in most cases further simplification is desired. Because the primary desired deflection is in the vertical axis, for projectors above or below the screen, a significant advantage can be obtained by using continuous horizontal facets. Stated differently, the facets, whether illuminated or occluded, may be at approximately the same slope, the width of the screen surface. Ideally, the illuminated facets may have variable slope defined by equation_{—}1. The slope of the illuminated facets may vary vertically or horizontally. In one embodiment, the slopes of the occluded facets may be substantially constant and the slopes of the illuminated facets may vary. In another embodiment, the slopes of the occluded facets may be substantially constant and the slopes of the illuminated facets may also be substantially constant. The draft angle may continuously vary according to equation_{—}2, replacing h with (h+y) where y is the vertical position on the screen. However, for simplicity, it may be sufficient to use the same minimum draft of equation_{—}2 across the whole screen. In one embodiment, the slope of the occluded facet angle or the draft angle may be designed for the worst case in that light may not illuminate the occluded facet at any angle, thus the slope may be acceptable in almost all cases.

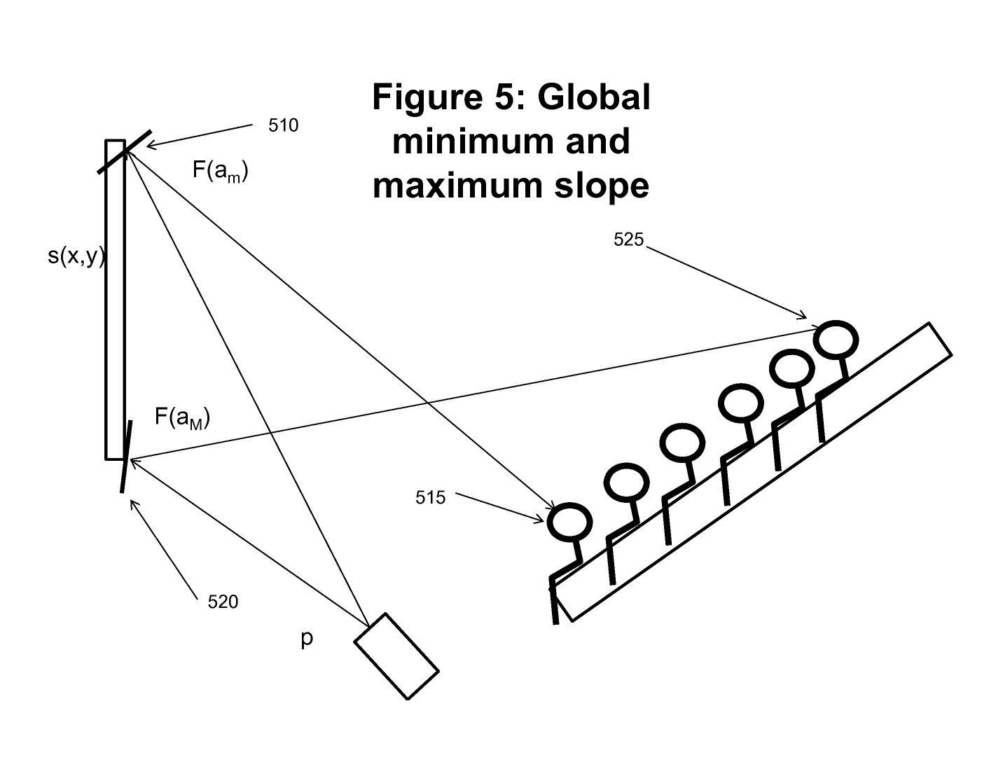

Screens may be constructed by seaming together multiple sheets of roll stock, and it may be impractical to locally tailor the facet angles. Instead, a mean facet angle may be chosen and the local spread in slopes may be increased so that most to all viewing locations may receive light from most to all screen locations. The ideal mean facet angle arranges for the center of the screen to be brightest when viewed from the center of the viewing area, in accordance with the following equation_{—}3:

$${\vert F ( {a}_{c} , p ) \vert}_{mean} = ( \frac{{a}_{c} - s ( \frac{w}{2} , h / 2 )}{\vert {a}_{c} - s ( \frac{w}{2} , h / 2 ) \vert} + \frac{p - s ( \frac{w}{2} , h / 2 )}{\vert p - s ( \frac{w}{2} , h / 2 ) \vert} ) \qquad ( equation\_ 3 )$$

in which w is the screen width and h is the screen height. The facet slopes may be in an approximate slope range of slopes bracketed by the globally required maximum and minimum as shown in FIG. 5. FIG. 5 illustrates a schematic diagram of the global minimum and maximum slope of a projection system. As shown in FIG. 5, there is a global maximum and minimum slope that may be primarily determined by the closest and farthest viewing locations. Also illustrated in FIG. 5, the slope of the illuminated facets may change from the top to the bottom of the screen and the slope may be determined by the location of the projector, the location of the screen, and/or the viewing area, or any combination thereof as appropriate. In FIG. 5, for the example screen system 500, the top facet 510 may have a slope so that the bottom viewer in the audience 515 may receive light reflected off of the top facet 510. Similarly, the bottom facet 520 may have a slope so that the top view in the audience 525 may receive light reflected off of the bottom facet 520.

The maximum slope required of the diffuser in order to illuminate all viewing locations is determined by the projector location relative to top of the screen the as well as the vertical and horizontal position of the closest viewer (height above the bottom of the screen and distance from the screen). The minimum slope is determined by the projector location relative to the bottom of the screen and the most extreme viewing angle. In many cases, this most extreme viewing angle may be at the back of the auditorium and above the bottom of the screen. However, in some situations such as classroom or other presentation setting, the most extreme viewing angle may be determined by a viewer who has approached the screen at a close distance.

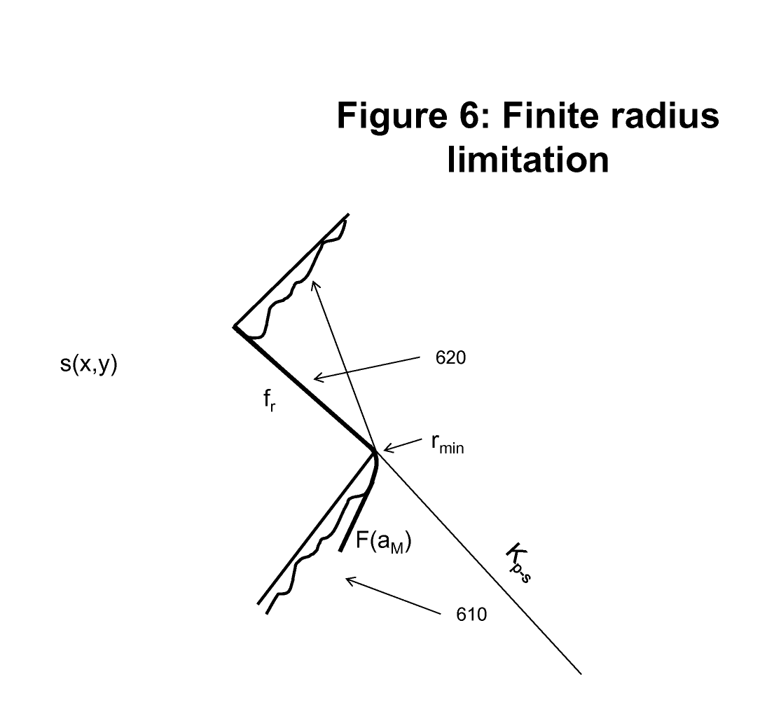

At the interface between the illuminated facet and the draft or occluded facet, there is the opportunity for light depolarization. The edge may be produced with a finite radius depending upon the manufacturing method as shown in FIG. 6. FIG. 6 illustrates a schematic diagram of the finite radius limitation of a projection screen surface. As shown in FIG. 6, the illuminated facet 610 to the occluded facet 620 creates an edge. This edge may scatter light. If the radius is less than approximately the wavelength of the illumination light, then the edge may scatter light. This scattered light can be assumed to be approximately depolarized and may illuminate both the viewing region and the adjacent facet. The portion of the light that illuminates the adjacent facet may be largely reflected into the viewing region. If the radius is significantly larger than the wavelength of light, then the reflection may largely preserve polarization but may direct a significant amount of the light to the adjacent facet where it may experience a second reflection before being directed primarily into the viewing region (with the wrong polarization). Thus, minimizing the radius is preferred because only half of the scattered light contributes to depolarization and that light is generally only coming from a much smaller area of the surface. The transition from F(a_{M}) to fᵣ may call for a finite radius rₘᵢₙ, as the rays reflected from this edge region may encounter the next ridge for a second reflection. For infinitesimal rₘᵢₙ, the edge may scatter.

In both cases, the intensity of the depolarized light can be reduced by blackening the edge between the facet and the draft. For larger facets, this may be done by directly ink jet printing black ink on the edge. For smaller facets, it may be more convenient to apply the ink use a gravure-process: the edges represent the highest points on the surface and so these may contact an ink roller while preventing the illuminated surfaces of the facets from contacting.

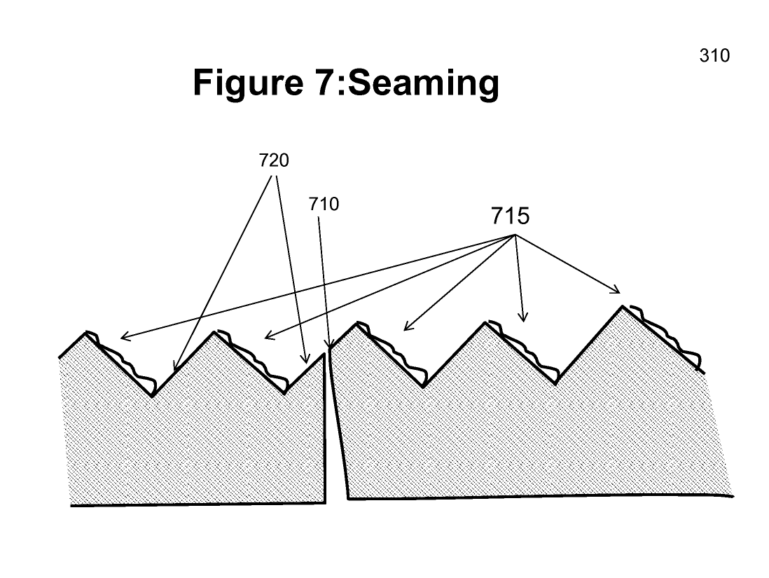

Roll to roll (R2R) coating methods are available which may enable construction of screens of up to about one and a half meters. In order to make screens significantly larger than this, or to use narrower R2R webs, the substrate may be seamed together. For close, less than approximately 1.5 m, or very bright viewing conditions, greater than approximately 10 fL, the seam gap may be less than thirty microns in width and in some cases less than ten microns. Such seams are possible using precision laser slitting and careful alignment. However, if the seam lands within the middle of an illuminated facet, then its apparent width may be magnified. Therefore, care may be taken such that the seam lands within the dark or occluded draft as shown in FIG. 7. FIG. 7 illustrates a schematic diagram of the seaming of a projection screen. When that is accomplished then the seam is effectively invisible. As shown in FIG. 7, the seam 710 falls on a occluded facet 720 and not on the illuminated facets 715.

As may be used herein, the terms “substantially” and “approximately” provide an industry-accepted tolerance for its corresponding term and/or relativity between items. Such an industry-accepted tolerance ranges from zero percent to ten percent and corresponds to, but is not limited to, component values, angles, et cetera. Such relativity between items ranges between approximately zero percent to ten percent.

While various embodiments in accordance with the principles disclosed herein have been described above, it should be understood that they have been presented by way of example only, and not limitation. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

1. A directional polarization preserving screen, comprising:
a substrate; and
a periodic diffuser structure disposed on the substrate, the periodic structure comprising:
a plurality of illuminated facets and a plurality of occluded facets, wherein the illuminated and the occluded facets are connected to and alternate with one another respectively, further wherein the illuminated facets substantially direct light to a predetermined area.

2. The directional polarization preserving screen of claim 1, further wherein the periodic diffuser structure allows incident light to undergo locally specular reflections.

3. The directional polarization preserving screen of claim 1, wherein the plurality of occluded facets are substantially hidden from projector illumination.

4. The directional polarization preserving screen of claim 1, wherein the plurality of illuminated facets further comprise features smaller than a wavelength of illumination.

5. The directional polarization preserving screen of claim 1, wherein the plurality of illuminated facets are smaller than the resolvable area on the substrate.

6. The directional polarization preserving screen of claim 1, wherein the illuminated facets are smaller than approximately 600 microns.

7. The directional polarization preserving screen of claim 1, wherein the illuminated facets are smaller than the pixel size of a projector.

8. The directional polarization preserving screen of claim 1, wherein the plurality of illuminated facets and the plurality of occluded facets comprise continuous horizontal facets.

9. The directional polarization preserving screen of claim 1, wherein the plurality of illuminated facets have a variable slope.

10. The directional polarization preserving screen of claim 9, wherein the variable slope of the plurality of illuminated facets change vertically.

11. The directional polarization preserving screen of claim 9, wherein the slope of the plurality of illuminated facets approximate an elliptical surface.

12. The directional polarization preserving screen of claim 1, wherein the plurality of illuminated and occluded facets are coated with an engineered polarization preserving pigment.

13. A method for directing projection light, comprising:
allowing projection light to reflect off of a plurality of illuminated facets disposed on a projection screen; and
substantially preventing projection light from reflecting off of a plurality of occluded facets disposed on the projection screen, wherein the illuminated and occluded facets connect to and alternate with one another, respectively.

14. The method for directing projection light of claim 13, further comprising primarily determining the bias angle from the slope of the illuminated facets.

15. The method for directing projection light of claim 13, further comprising allowing ambient light to be steered away from a predetermined area.

16. The method for directing projection light of claim 14, wherein allowing projection light to reflect off of a plurality of illuminated facets disposed on a projection screen further comprises, allowing the projection light to be directed to a predetermined area.

17. The method for directing projection light of claim 16, further comprising allowing incident light to undergo locally specular reflections.

18. The method for directing projection light of claim 13, wherein the plurality of illuminated facets and the plurality of occluded facets comprise continuous horizontal facets.

19. The method for directing projection light of claim 13, further comprising varying the slope of the illuminated facets.

20. The method for directing projection light of claim 19, wherein the slope of the plurality of illuminated facets varies vertically.

21. The method for directing projection light of claim 13, further comprising approximating an elliptical surface with the slope of the plurality of illuminated facets.

22. The method for directing projection light of claim 13, further comprising coating the plurality of illuminated and occluded facets with an engineered polarization preserving pigment.
